(19) United States
(12) Patent Application Publication
(10) Pub. No.: US 2006/0063091 A1
(43) Pub. Date: Mar. 23, 2006

(54) Toner classification device, and toner manufacturing method

(76) Inventors: Nobuyasu Makino, Numazu-shi (JP); Fumitoshi Murakami, Fuji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/228,547

(22) Filed: Sep. 19, 2005

(30) Foreign Application Priority Data
Sep. 17, 2004 (JP) 2004-272436
Mar. 16, 2005 (JP) 2005-075244
Jul. 27, 2005 (JP) 2005-216675

(51) Int. Cl. G03G 9/08

(52) U.S. Cl. 430/110.4; 430/137.2

(57) ABSTRACT

A toner classification device including a casing including at least one classification space. Each of classification includes a classification rotor and a toner discharging outlet. At least a portion of the surface of a part of the inner surface of the toner classification device which toner particles contact includes a blast-treated surface.

### BACKGROUND OF THE INVENTION

1. Field of the Invention

The present invention relates to a toner classification device for use in image formation methods such as electrophotography, electrostatic printing methods and toner jet type recording methods, and a toner manufacturing method.

2. Discussion of the Background

In image forming methods such as electrophotography, toners are used to develop electrostatic images. Toner manufacturing methods are typified into pulverization methods and polymerization methods. Pulverization methods are relatively easy and popular methods in comparison with polymerization methods. In typical manufacturing methods based on such pulverization methods, binder resins functioning as a fixation agent to a recording material and a colorant functioning as a color of a toner are mixed together with external additives such as a charge controlling agent, a magnetic material to impart a transferability to toner itself, a release agent, and a fluidizer if necessary. The resultant is melted and kneaded. Subsequent to cooling and solidification, the mixture is finely pulverized by a pulverization method and classified by a classification method to obtain particles having a desired particle size distribution. Further, a fluidizer, etc., are added to the resultant to obtain a toner for use in image formation. When it comes to the case of a toner for use in a two-component developing method, the toner mentioned above is mixed with one of various kinds of magnetic carriers to form a developer for use in image formation.

Recently, a resin having a low melting point and a release agent, typically a wax, to obtain a high definition, have been contained in a toner as a toner material for high speed printing and such a toner has begun to be dominant in the market. This type of toner causes a problem in that, since such a wax tends to surface on the boundary phase of a toner particle or to be detached and separated therefrom, the wax tends to attach to the inner side of a manufacturing device such as a classifier, a pulverizer and a mixer due to the stickiness of the wax rooting from its characteristics, i.e., a low molecular weight and a low melting point.

FIG. 6 is a block diagram illustrating an example of a background fine powder manufacturing system (toner manufacturing system). This system has a pulverization device (831) to pulverize a material and a classification device (832) to perform classification based on the particle size of the pulverized material.

In the system illustrated in FIG. 6, particles which have been pulverized by a pulverization device (831) are classified according to particle size by a classification device (832) into coarse particles having a larger particle diameter than a desired particle diameter, middle-sized particles having a desired particle diameter, and fine particles having a smaller particle diameter than the desired particle diameter. The coarse particles are re-pulverized by the pulverization device (831) and supplied to the classification device (832) again. The fine particles are returned to a material mixing process. Any known air pulverizer and mechanical pulverizer can be uses as the pulverization device. In addition, as for the classification device (832), known classifiers such as multi-separation air classifiers and air separation classifiers can be used.

Various kinds of pulverizers can be used as the pulverization device (831). An air jet pulverizer using jet air having a cross section illustrated in FIG. 7, especially a collision type air pulverizer, is used in many cases. Powder is transferred by a high pressure air such as jet air and blasted through an outlet (163) of an acceleration tube (162) to a collision face (166) of a collision member (164) provided opposing the mouth phase of the outlet (163) of the acceleration tube (162). The powder is pulverized by an impact of collision at the collision face (166).

In the collision type air pulverizer illustrated in FIG. 7, a collision member (164) is provided opposing the outlet (163) of an acceleration tube (162) to which a high pressured air supplying nozzle (161) is connected. Powder to be pulverized is sucked from a pulverization material supplying mouth (165) provided to communicate in the middle of the acceleration tube (162). The material sucked in the acceleration tube (162) is blasted with high pressure air supplied from the acceleration tube (162) to the collision face (166) of the collision member (164). The powder is pulverized by the collision. The pulverized material is discharged from an outlet (167) for the pulverized material.

A rotation type mechanical pulverizer is also used. This rotation type mechanical pulverizer is more efficient than an air jet pulverizer in light of energy consumed. FIG. 8 is a diagram illustrating such a pulverizer described in published unexamined Japanese patent application No. (hereinafter referred to as JOP) 2003-173046. The numeral references assigned therein are according to those in JOP 2003-173046. This mechanical pulverizer pulverizes a powder material by introducing the powder material into a circular space formed between a rotor (316) rotating at a high speed and a stator (310) provided around the rotor (316). Although such a rotation type mechanical pulverizer is slightly inferior to an air jet pulverizer as to the pulverization limitation on the particle size, the rotation type mechanical pulverizer can pulverize a powder material to particles having a particle diameter not less than 7 to 8 μm with significantly less energy. In addition, a powder material is rarely excessively pulverized so that fewer fine or super fine particles are produced, resulting in an increase in yield of toner particles.

Further, JOP 2003-280263 describes a fluidized tank type pulverization classifier, which is a kind of fine pulverization device. FIG. 9 is an edge cross section illustrating an example equivalent to the fluidized tank type pulverization classifier described in JOP 2003-280263. This type of classifier typically has a fluidizing portion (403) having a cylindrical form and multiple air nozzles (401) disposed at the bottom portion of the external wall of the fluidizing portion (403), which function as a pulverization device while being directed toward the center of the fluidizing portion (403). Toner materials (402) to be pulverized which are input from an inlet (407) are pulverized when suspended high pressured jets blasted from the air nozzles (401) collide with each other in the fluidizing portion (403). In this structure, a classification device is built with the pulverizer. Therefore, pulverized powder is rapidly transferred to a classification rotor (404) located at the upper portion of the fluidizing portion (403) to avoid excessive pulverization while the pulverization efficiency is maintained. Particles having a desired particle diameter are classified and selected by the classification rotor (404).

Next, as a classifier, a multiple separation air classifier is known. For example, JOP 2003-173046 describes such a classifier. FIG. 10 is a side view cross section illustrating the multiple separation air classifier described in JOP 2003-173046.

As other classifiers, mechanical centrifugal type wind classifiers (referred to as toner separator (TSP)), which are described in JOPs H10-118571 and 2001-104888, are known. This classifier performs classification using the balance between the centrifugal force generated by a blade provided to a rotating rotor and the centripetal force generated by the suction force of a fan. FIG. 11 is a side view cross section of the classifier (TSP) described in JOP H10-118571. The last low two digits of the numeral references (701, etc.) assigned in FIG. 12 correspond to those of the numeral references in JOP H10-118571.

This vertical axis type air classifier includes a casing (701) having an outlet (723) for fine particles and an outlet (724) for coarse particles, a classification rotor (708) having a guide blade (709) which has a bearing on its half portion, a driving axis (702) for the classification rotor (708) which has a bearing on its half portion, a portion of supplying a material to be classified which has a portion supplying air in a tangent direction located at the same height as the classification rotor (708), immovable guiding blade rings (703) disposed in the circumference surface of the classification rotor (708) in its radius direction with an interval, and a classification space (721) having a ring form limited by the guiding blade rings (703). The driving axis (702), a fine particle discharging space (714) having a ring form coaxially disposed on the driving axis (702), a coarse particle discharging space (713) having a ring form coaxially disposed on the driving axis (702), and a classification rotor bearing supporting device are arranged on the same side based on the classification rotor (708) and therebelow.

A ring disc (720) fixedly connected to the rotating classification rotor (708) is disposed on the inner side of the coarse particle discharging space (713). In addition, the ring disc (720) extends along the inner side wall and the base of the coarse particle discharging space (713) having a ring form based on the radius direction thereof. The classification rotor (708) has guiding blades (709) on its peripheral portion. In addition, around the outer circumference of the classification rotor (708), an eddy member (729) is provided having a spiral form coaxially disposed with regard to the classification rotor (708). A classifier having a similar structure to this classifier is described below as an embodiment while describing each portion in detail.

Other classifiers, for example a paddle wheel type classifier, are known (refer to JOP 2001-293438). This type of classifier is referred to as a tandem toner separator (TTSP). FIGS. 12A and 12B are diagrams illustrating the classifier described in JOP 2001-293438 as an example of this type of mechanical centrifugal type wind classifier.

The illustrated classifier (800) includes casings (803) and (804) including classifying paddle wheel type classification rotors (805) and (809), respectively. The classification rotors can be driven by motors (808) and (812), respectively. Further, the paddle wheel classification rotors (805) and (809) are removably supported on their one side in casings (803) and (804), respectively. Each classification rotor (805) and (809) coaxially disposed has closed cover discs (815) and (816), respectively, at the first end thereof in the axial direction and further, a fine particle or middle-sized particle retrieving mechanism at the second end in the axial direction.

Between the ends of each classification rotor (805) and (809) opposing each other, the faces of the first ends of both classification rotors (805) and (809) are disposed facing each other while a minute fluidizing space is formed in the axial direction.

Each of the paddle wheel classification rotors (805) and (809) has a classification air supplying portion (819) and (820), respectively, in one tangent direction. Each classification air supplying portion (819) and (820) is disposed at the height of each classification rotor (805) and (809) and has immovable guide blade rings. The immovable guide blade rings are disposed with an interval from the circumference portion of the classification rotors (805) and (809) along the radius direction. Further, each of the paddle wheel classification rotors (805) and (809) has a portion to supply materials to be classified (817), a classified material retrieving mechanism (818), and a classification area. Refer to JOP 2001-293438 for other detailed descriptions.

The classified materials pass through this classification area and are extensively fluidized along the axial direction of the classification rotors (805) and (809). The number of rotations of each classification rotor (805) and (809) can be set to be the same or different. Multiple-step classification corresponding to each classification rotor can be simultaneously

Recently, in response to the demand for high quality images, toners having a sharp particle-size distribution which are excellent in dot reproduction resulting from small dot variance in the development and transfer processes have been demanded. Therefore, a manufacturing device by which toners having a particle diameter not greater than 4 μm can be precisely classified and by which toners having a particle diameter not less than 5 μm can be obtained with a high yield have been demanded.

In addition, in recent years, considering the following demand, toners easy to melt and attach have been especially used. That is: (1) toners which can be fixed at a low temperature in light of reduction of consumed energy; (2) a binder resin having a low softening point in consideration of color mixing property in the case of a color toner; and (3) toners containing a release agent suitable for oilless fixing.

These toners are easily attached or melted and attached to the inner side of a puleverizer, a classifier, and a mixer. Especially, as for a toner containing a release agent, toner attachment and melted toner attachment tend to occur at a high rate, which is a significant problem. When such attachment and fixation occur in a pulverizer or a classifier and increase, the productivity of a toner deteriorates. In addition, agglomerated bodies of toner can be detached and such detached agglomerated bodies cause the density of dust in the classifier in operation to vary in a pulse manner. Thereby, the accuracy of classification deteriorates. Further, in a mixer, interfusion of fixated toner degrades the quality of product, which leads to deterioration of quality of images.

The drawbacks mentioned above stand out in TSPs and TTSPs (refer to FIGS. 11 and 12A to 12B). TSPs and TTSPs are excellent in classification but have a narrow gap between the rotator and the stator thereof. Therefore, toner attachment and melted toner attachment at the narrow gap is especially a problem.

The main process of how toner attaches or fixes in a TSP or TTSP while such a device is in a continuous operation is as follows:
1) At a classification rotor, since the gap is narrow, fixation occurs at the outer circumference, and the fixated material is detached therefrom and interfuses into coarse particles (product);
2) In a classification space, toner floating time varies due to toner attachment, which leads to deterioration of classification accuracy;
3) At a coarse particle (product) outlet, when the amount of toner attachment increases, discharging becomes difficult, resulting in operation stoppagepage caused by excessive load on the classification rotor;
4) At a discharging ring for coarse particles, attached toner accumulates, resulting in occurrence of melted toner attachment, which leads to operation stoppage; and
5) At an eddy member, attached toner accumulates, which causes decrease in the amount of inlet air so that the accuracy of classification deteriorates, which leads to operation stoppage.

The technology described in JOP 2003-173046 mentioned above is known as a technology to prevent such attachment. In JOP2003-173046, the following toner production process is described: The toner production process includes at least the steps of melting and kneading a mixture containing at least a binding resin and a colorant, cooling the resulting kneaded material, coarsely grinding the cooled material, pulverizing the coarsely ground material using a grinding device, and classifying the resulting pulverized powder using a classifying device. The grinding device includes a mechanical grinding machine having at least a rotor (314) (FIG. 8) which is a rotator attached to the center rotating shaft (312) and a stator (310) which is provided around the rotor (314), keeping a constant gap between the stator (310) and the surface of the rotor (314). The grinding machine is constructed such that a circular space formed by maintaining the gap remains airtight, and the surface of at least one of the rotors (314) and the stators (310) is coated by the plating of a chromium alloy containing at least chromium carbide.

JOP H11-197607 describes a method using an inertial classifier having a composite surface treated layer covered by applying fluorocompound treatment to surfaces of classifying edges determining a classifying point after metal thermal spraying. A toner for electrophotography is manufactured by using this classifier. That is, when the toner for electrophotography is manufactured by fusion kneading, grinding and classifying a mixture containing at least a binder resin and a coloring agent, the ground product is classified with the above-mentioned inertial classifier.

JOP 2001-255704 describes a method using a mechanical pulverizing machine which is constituted in such a manner that a pulverizing device has at least the rotor or rotating body mounted at a central revolving shaft and the stator arranged around the rotor by maintaining a specified spacing from the rotor surface, and such that an annular space formed by maintaining the spacing attains a hermetic state. The method of manufacturing the toners is characterized in that the surface of the rotor and/or the stator is subjected to a surface roughening treatment and that the surface subjected to the surface roughening treatment is subjected to a wear resistant treatment.

However, the chromium alloy containing at least chromium carbide of JOP 2003-2173046 or the fluorine containing compound JOP H11-197607 has a relatively high electric resistance in comparison with that of a metal. Therefore, there is a problem that attachment to the inner side of the device progresses a little by little by friction charge with a powder, resulting in deterioration of prevention effect of fusion attachment. In addition, there is another problem that the coated surface is not strong enough so that the device must be dissembled and re-coated after an extended period of use.

The blast treatment described in JOP 2001-255704 is just a pre-treatment simply to improve the adhesion strength of an anti-abrasion treatment agent.

While particles having a particle diameter of around 200 μm enter into a pulverizer, particles thrown into a classifier have a particle diameter of around 20 μm at maximum.

### SUMMARY OF THE INVENTION

Therefore, the inventors of the present invention recognize a need for a toner manufacturing facility and method by which it is possible to prevent toner from attaching to at least part of the inner side of a manufacturing device and the surfaces of the parts thereof to secure stably accurate classification of toner for an extended period of time while producing such toner with a high yield.

Therefore, an object of the present invention is to provide a novel toner manufacturing facility and method by which it is possible to prevent toner from attaching to at least part of the inner side of a manufacturing device and the surfaces of the parts thereof to secure stably accurate classification of toner-for an extended period of time while producing such toner with a high yield to improve the quality of images.

Briefly, this object and other objects of the present invention as hereinafter described will become more readily apparent and can be attained, either individually or in combination thereof, by a novel toner classifier for use in manufacturing electorphotographic toner, in which at least part of the inner surface of the toner classifier and the surface of the parts thereof is blast-treated.

In one preferred embodiment, the classifier mentioned above can be structured in such a manner that the classifier contains a casing having one or more classification spaces each of which contains a classification rotor and are coaxially arranged relative to each other.

In another preferred embodiment, the roughness of the blast-treated surface, i.e., the surface state, of the classifier mentioned above, is preferably that Ra is 0.05 to 1.0 μm.

In another preferred embodiment, the roughness of the blast-treated surface, i.e., the surface state, of the classifier mentioned above, is preferably that Ry is 1.0 to 5.0 μm.

In another preferred embodiment, the roughness of the blast-treated surface, i.e., the surface state, of the classifier mentioned above, is preferably that Rz is 1.0 to 5.0 μm.

In another preferred embodiment, the roughness of the blast-treated surface, i.e., the surface state, of the classifier mentioned above, is preferably that Rq is 0.5 to 1.0 μm.

In another preferred embodiment, it is preferred that one of plastic fine particles, glass fine particles, metal fine particles and metal spherical fine particles is used as the blast treatment agent.

In another preferred embodiment, it is preferred that, in the classifier mentioned above, at least part of the surface of the classification rotor is blast treated.

In another preferred embodiment, it is preferred that, in the classifier mentioned above, at least part of the surface of the classification space is blast treated.

In another preferred embodiment, it is preferred that, in the classifier mentioned above, at least part of the inner wall of the toner discharging outlet is blast treated.

In another preferred embodiment, it is preferred that the classifier mentioned above further includes a toner discharging ring disposed at an end in an axial direction of the casing and the toner discharging ring is blast treated.

In another preferred embodiment, it is preferred that the classifier mentioned above further includes an eddy member disposed at a lateral face of the casing, and the eddy member is blast treated.

As another aspect of the present invention, a novel method of manufacturing a toner is provided which include the steps of pulverizing a material containing a binder resin with a pulverizing device, classifying the pulverized material with a classification device including a casing including at least one classification space including a classification rotor and a toner discharging outlet, and at least part of the inner surface of the toner classification device and the surfaces of the parts thereof which toner particles contact are blast-treated.

As another aspect of the present invention, a novel blast treatment method is provided including blast treating at least part of at least one of the inner surface of a classification device and the surfaces of the parts thereof, which toner particles contact with fine particles having a hardness of from 3 to 8 on Mohs hardness.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a block diagram illustrating a schematic structure of a powder manufacturing system (toner manufacturing system) of the present invention;

FIG. 2 is a longitudinal cross section illustrating the first embodiment of the classifier of the present invention;

FIGS. 3A to 3D are horizontal sections (A) to (D) of the classification blade ring of the classification of FIG. 2;

FIG. 4 is part of a fractured perspective view illustrating a schematic structure of the second embodiment of the classifier of the present invention;

FIG. 5 is an enlarged cross section of a portion of the classifier of FIG. 4;

FIG. 6 is a black diagram illustrating an example of a background fine powder manufacturing system (toner manufacturing system);

FIG. 7 is a cross section illustrating an example of a background collision type air pulverizer for toner manufacturing;

FIG. 8 is a cross section illustrating an example of a background rotation type mechanical pulverizer for toner manufacturing;

FIG. 9 is a side view cross section illustrating an example of a background fluidized tank type pulverizer for toner manufacturing;

FIG. 10 is a side view cross section illustrating an example of a background multiple separation type air classifier for toner manufacturing;

FIG. 11 is a side view cross section illustrating an example of a background mechanical centrifugal type wind classifier (TSP) for toner manufacturing; and

FIGS. 12A and 12B are diagrams illustrating an example of a background mechanical centrifugal type wind classifier (TTSP) for toner manufacturing.

### DETAILED DESCRIPTION OF THE INVENTION

The toner classification of the present invention is a toner classifier for use in manufacturing electorphotographic toner in which at least part of the inner surface of the toner classifier and the surface of the parts thereof is blast-treated. Thereby, toner does not attach to the inner side of such a device, and therefore, the device can operate for a long time while securing a stably precise classification.

In addition, the classifier mentioned above can be structured in such a manner that the classifier contains a casing having one or more classification spaces each of which contains a classification rotor, and that are coaxially arranged relatve to each other. The roughness of the blast-treated surface, i.e., the surface state, of the classifier, is preferably that Ra is 0.05 to 1.0 μm, Ry is 1.0 to 5.0 μm, Rz is 1.0 to 5.0 μm, and Rq is 0.5 to 1.0 μm.

It is also preferred that one of plastic fine particles, glass fine particles, metal fine particles and metal spherical fine particles having a particle diameter of from 3 to 100 μm, and preferably from 5 to 30 μm, is used as the blast treatment agent.

Further, Ra and others are controlled by blasted materials, particle size, specific absolute specific gravity, amount of blast injection, injection time, and underlayer treatment. The most preferred conditions after spraying the blasted materials are set to be that Ra is 0.1 to 1.5 μm, Ry is 0.5 to 3.0 μm, Rz is 0.5 to 3.0 μm and Rq is 0.6 to 0.8 μm. Under the most preferred conditions, the amount of toner attachment in the inside of a device is significantly reduced.

In addition, the conditions under which the surface state mentioned above can be efficiently achieved is preferably that, after underlayer treatment with a blasted material formed of one of plastic fine particles, glass fine particles, and metal fine particles, a blast treatment is performed with a blast material formed of metal spherical fine particles having a particle diameter of from 3 to 50 μm. However, the blast conditions are not limited thereto because the blast conditions vary depending on the toner materials to be pulverized and classified and the adopted mechanical system.

When a classification rotor, a classification space, the inner wall of a toner discharging outlet, etc., is blast-treated, a toner attachment prevention effect is efficiently improved. It is also effective to blast-treat a toner discharging ring disposed at the end of a classification space in the axial direction and an eddy member disposed at the side of a classification space.

In addition, the same treatment can be applied to a toner pulverizer and a toner mixer. The same prevention effect can be obtained in both cases. It may also be beneficial to blast-treat the surface of a rotor and/or a stator and/or a toner discharging portion forming a toner pulverizer to efficiently obtain a sufficient result.

In addition, in the present invention, the manufacturing facilities mentioned above are used to manufacture a toner, by which a quality toner can be manufactured. Further, as a result of the decrease in frequency of checking and maintenance for a facility, the maintenance cost is reduced.

The present invention will be now described below in detail with reference to several embodiments and accompanying drawings.

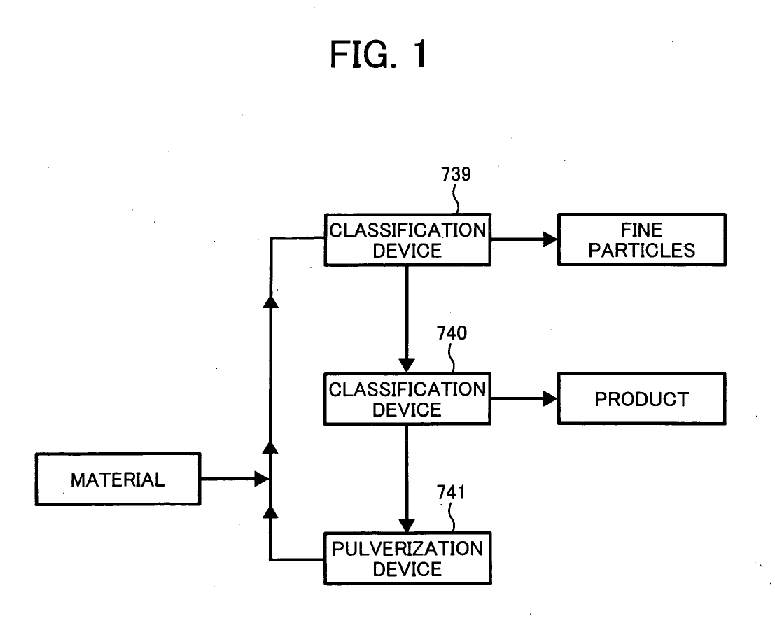

FIG. 1 is a block diagram schematically illustrating an outlined structure of the powder manufacturing system (toner manufacturing system) of the present invention. The system illustrated in FIG. 1 includes a classification device (739) to classify fine particles having a particle diameter having less than a regulation particle size, a classification device (740) to classify coarse particles classified by the classification device (739) into fine particles (product) having a regulation particle diameter and coarse particles having a particle diameter greater than the regulation particle size, and a pulverization device (741) to re-pulverize the coarse particles classified at the classification device (740). The coarse particles re-pulverized at the pulverization device (741) are supplied back to the classification device (739). The fine particles classified at the classification device (739) are retrieved and melted to form a lump. Thereafter, the lump is re-pulverized and used as a material to be pulverized again.

In this system, each of the classification devices (739) and (740) to classify particles and the pulverization device (741) to re-pulverize the pulverized toner are subject to blast-treatment described later. Various kinds of known configurations can be applied to the structure of the pulverization device (741), and the classification devices (739, 740). It is preferred that each of the pulverization device (741) and classification devices (739, 740) are blast-treated, but in the toner manufacturing system of the present invention, the system in which at least one of the pulverization device (741) and the classification devices (739, 740) of the present invention is used is included.

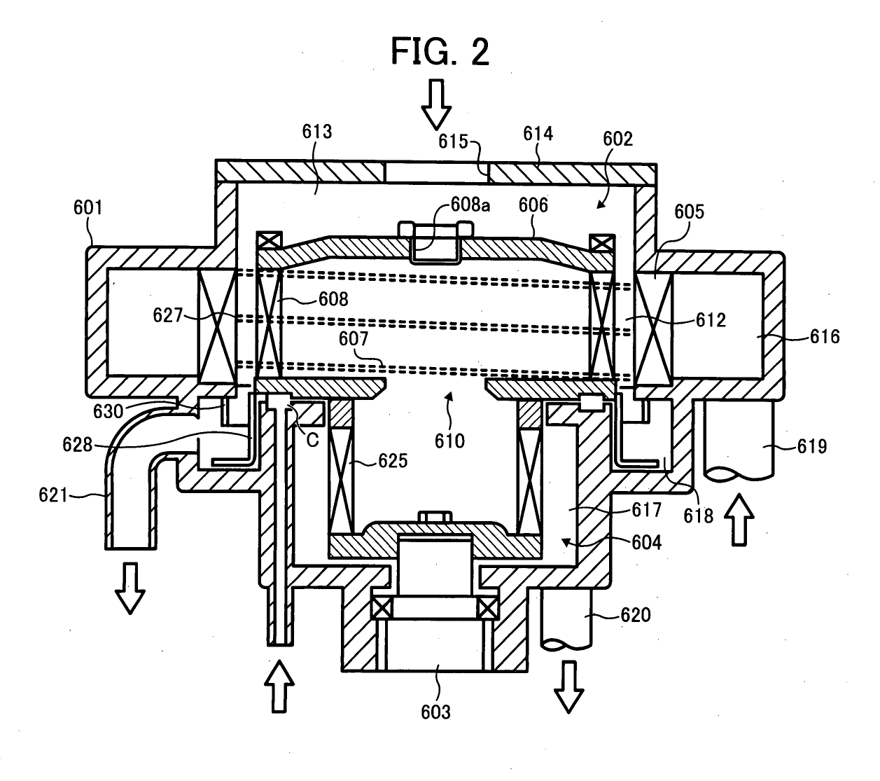

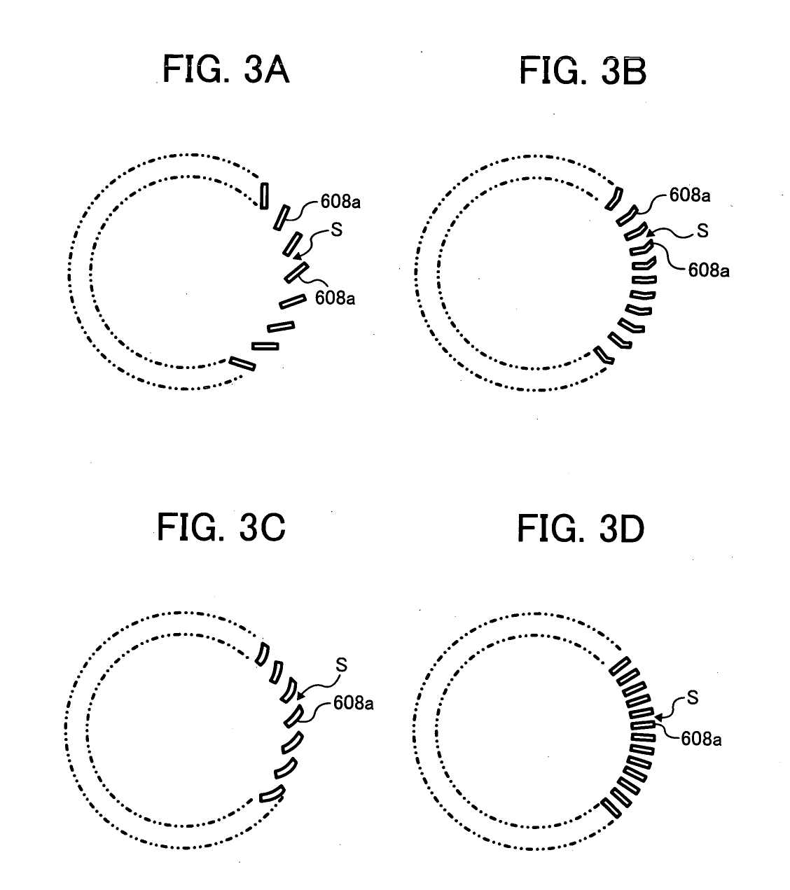

Next, the classification device in the first preferred embodiment of the present invention is described with reference to the following drawings. FIG. 2 is a longitudinal cross section illustrating the first embodiment of the classification device of the present invention, and FIG. 3 is a cross section illustrating a classification blade ring.

The classification device (739 and/or 740) (TSP) illustrated in FIG. 2 is a mechanical centrifugal type wind classification device. The classification has a casing (601) including a classification rotor (602) which is a solid rotation body attached to a rotation axis, and a classification space (612) provided outside the classification rotor (602). The classification rotor (602) supplies toner to be classified therein to the classification space (612) by centrifugal force. To the classification space (612), classification air for classification is supplied via a classification air supply route. This classification air is supplied via a classification air supply device (619). This classification air supply device (619) is typically provided on the outer surface of the classification space (612). The classification rotor (602) preferably has a classification blade (608a) functioning as a distribution device to distribute and discharge toner to be classified to the classification space (612). The classification blade (608a) is preferably provided to the outer surface of the classification rotor (602) (that is, on the side of the classification space). A guiding blade ring (605) having a circular form functioning as an air distribution member is preferably provided between the opposite side (i.e., the outer surface of the classification space (612)) to the classification blade (608a) in the classification space (612) and the inner side of its adjacent classification air supply device (619). In other words, the inner side of the classification space (612) is divided from the outside of the classification rotor (602) by the classification blade (608a). In addition, the guiding blade ring (605) divides the outside of the classification space (612) from the inner side of the classification air supply device (619).

The device of this embodiment has a casing (601) and a classification rotor (602) (the total portions of (627) and (606) located outside the outer circumference of (608a)) having a cylindrical form disposed in the upper side of the casing (601). Further, the device of this embodiment includes a driving axis (603) vertically disposed below the classification rotor (602), a classification rotor supporting member (604) vertically supporting the classification rotor (602) while connecting the top end of the driving axis (603) and the bottom end of the classification rotor (602), and guiding blade rings (605) coaxially arranged along the outer circumference of the classification rotor (602) at the outer surface thereof in the radius direction with a spacing.

The guiding blade rings (605) are circularly disposed with a regular spacing in the direction parallel to the circumferential direction of the outer circumference of the classification rotor (602). The guiding blade rings (605) are formed of multiple guiding blades (605) vertically extending while fixed to the casing (601). The form of the cross section and the direction of the guiding blades (605) are formed such that the form of the cross section (627) of the gap having a slit form formed between the adjacent guiding blades has, for example, the form of the classification blade (608a) illustrated in FIGS. 3(A) to (D), to have a form suitable for the classification air stream.

As illustrated in FIG. 2, the classification blade ring (608) is formed of multiple vertically extending classification blades circularly arranged along the peripheral portion of a distribution disc (606) and a cover disc (607) with a regular spacing. The form of the cross section and the direction of the classification blade ring (608) are formed such that the form of the cross section of the gap (S) having a slit form formed between the adjacent classification blades (608a) is set to be a form suitable for the classification air stream, for example the form illustrated in FIGS. 3(A) to 3(D).

Back to FIG. 2, the casing (601) has an opening (613) on its upper side to insert and pull out the classification rotor (602). To the opening (613) is detachably attached a casing cover (614). At the center portion of the casing cover (614), a material inlet (615) is provided. Inside the casing (601), there are provided a circular classification air supplying space (616) coaxially arranged with the guiding blade ring (605) outside of the guiding blade ring (605), a circular fine powder discharging space (617) coaxially arranged with the driving axis (603) below the classification rotor (602), and a circular coarse powder discharging space (618) coaxially arranged with the driving axis (603) outside the fine particle discharging space (617).

The classification air supplying space (616) has a square cross section with its inner surface open and communicates with the classification space (612) via the slits (gaps) between the multiple guiding blades forming the guiding blade ring (605). To the classification supplying space (616), the classification air supplying device (tube) (619) is connected to let in the classification air from outside.

The fine particle discharging space (617) communicates to the inside of the classification rotor (602) via an interval web (625) provided to the classification rotor supporting member (604) and a piercing hole (610) provided to the cover disc (607). To the fine particle discharging space (617), a fine particle discharging tube (620) is connected as an outlet through which fine particles existing inside the fine particle discharging space (617) are discharged to the outside.

The coarse discharging space (618) is situated below the classification space (612) and communicates to the bottom end of the classification space (612). To the coarse particle discharging space (618), a coarse particle discharging tube (621) is connected as an outlet through which coarse particles (product) existing inside the coarse particle discharging space (618) are discharged to the outside.

Inside the classification space (612), an eddy member (627) having a spiral form to control floating time and agglomeration of materials to be classified existing in the classification space (612) is coaxially arranged with the classification rotor (602). The eddy member (627) is formed by spirally winding a member having a strip form and is fixed inside the guiding blade ring (605) while extending to the height direction of the classification space (612) substantially over the length thereof. A minute gap is formed between the inner circumference portion of the eddy member (627) and the outer circumference portion of the classification blade ring (608).

Inside the coarse discharging space (618), a coarse particle discharging member (628) having a ring form is concentrically arranged. The coarse particle discharging member (628) has a cross section of an L shape formed along the lateral side and the base of the inside of the coarse discharging space (618). The upper end of the coarse particle discharging member (628) is fixed to the cover disc (607) of the classification rotor (602). The coarse particle discharging member (628) integrally rotates with the classification rotor (602). By this rotation, coarse particles existing in the coarse particle discharging space (618) are fluidized, which promotes discharging of the coarse particles therefrom.

In the casing (601), the classification air supplying device (tube) (619) is formed to let in cleaning air to the gap formed between the casing (601) and the classification rotor (602). The top end of the classification air supplying device (tube) (619) communicates to a ring shaped air room (C) formed between the bottom face of the classification rotor (602) and the casing (601). The cleaning air supplied to the air room (C) flows into the coarse particle discharging space (618) through a minute gap formed between the bottom face of the classification space (602) and the casing (601). Further, the cleaning air flows into the coarse particle discharging tube (621) through a gap formed between the coarse particle discharging member (628) and the coarse particle discharging space (618) and thereafter is discharged to the outside. Thereby, coarse particles existing between the inner lateral side of the coarse particle discharging space (618) and the base of the coarse discharging member (628) can be removed.

A circular shaped pressing ring (630) is coaxially arranged on the upper part of the inner portion of the coarse particle discharging space (618). This circular shaped pressing ring (630) is fixed to the casing (601). Thereby, coarse particles existing in the coarse particle discharging space (618) are prevented from flowing back to the classification space (612).

In this embodiment, the blast-treatment described later is performed for the determined portion described later among portions the classified toner particles will contact (among the surfaces of the inner side of the classification device and the parts provided on the inner side of the classification device. For example, the outer circumference surface of the classification rotor (602) functioning as a rotor among the parts of the classification device and the surfaces of the eddy member (627) functioning as a stator, the guiding blade ring (605), and the product discharging portion can be blast-treated.

Due to the blast treatment, the surface state of each part is smoother compared with that achieved when each part is manufactured. In addition, scars on the parts can be mended, resulting in prevention of toner attachment.

Specific examples of the blasting materials for use in the present invention include SS such as SUS304, molybdenum steel, Ni—V steel. In the examples detailed later, SUS304 was used.

The typical operation of the classification device is now described. Classification air is supplied to the classification air room (616) via the classification air supplying device (tube) (619). This classification air is blown out to the classification space (612) via a gap formed in the guiding blade ring (605). Thereafter, the classification air flows into the inside of the classification rotor (602) in rotation by way of gaps formed in the classification blade ring (608). Materials to be classified input through the material inlet (615) are dispersed along all the circumference directions by the distribution disc (606) of the classification rotor (602) and thereby flow into the classification space (612).

The materials to be classified flown into the classification space (612) move downward along the upper face of the eddy member (627). While the materials to be classified pass through the classification space (612), fine particles having a small particle diameter flow into the inside of the classification rotor (612) on track of the classification air stream. The fine particles are directed downward along the axis together with the classification air stream and flow into the inside of the classification rotor supporting member (604) byway of the piercing hole (610) formed on the cover disc (607). These fine particles flow into the inside of the fine particle discharging space (617) by way of the gaps formed between the interval webs (625) and are discharged to the outside through the fine particle tube (620).

On the other hand, the coarse particles, which do not flow on track of the classification air in the classification space (612), move downward in the classification space (612) along the eddy member (627) and stop at the coarse particle discharging space (618). These coarse particles are fluidized by the coarse particle discharging member (628) and discharged to the outside via the coarse particle discharging tube (621).

In this embodiment, among the portions classified toner particles contact among the inner side of the classification device having such a known structure and the surface of the parts contained in the classification device, blast-treatment is performed to the following portions (a) to (e), so that those portions have resulting blast-treated surface to have a characteristic that toner attachment is efficiently prevented:
(a) for the classification rotor (602), blast-treatment is performed to its outer circumference surface;
(b) for the classification space (612), blast-treatment is performed to its inner circumference surface;
(c) for the coarse particle discharging tube (outlet) (621), blast-treatment is performed to the inner circumference surface of the outlet;
(d) for the distribution disc (606), blast-treatment is performed to the surface of the member; and
(e) for the eddy member (627), blast-treatment is performed to its surface.

The blast treatment mentioned above can be performed to all the inside of the device and all the surfaces of all the parts of the device. However, in this embodiment, blast-treatment is limited only to effective portions in consideration of cost, but other portion could also be blast-treated. For example, as mentioned above, blast-treatment to the surface of the classification blade ring (608) functioning as a stator, the guiding blade ring (605) functioning as a stator, and the eddy member (627) among the parts of the classifier can significantly contribute to prevention of toner attachment. In general, when blast-treatment is selectively (i.e., not all parts of the classifier) performed in a concentrated manner to high speed operating portions, small gap portions, members which move relatively fast against each other, and portions where the density of toner is high, cost performance and efficiency are good.

In the present invention, to form a smooth surface on the portions as mentioned above, a blast processing treatment is preferably performed with fine particles having 3 to 8 on Mohs hardness.

For example, glass beads such as soda lime glass having a particle diameter selected from about 10 to about 100 μm are sprayed to the surface to be blasted with air of 0.3 to 0.8 Mpa. Hard resin particulates such as polycarbonate resins, polyester resins, urea resins, melamine resins, polyamide resins, and polypropylene resins can be used as a blast material. Such resin particulates preferably have a particle diameter of from 50 to 2,000 μm, and more preferably from 100 to 1,500 μm and preferably have a form close to a sphere. In addition, blast processing can be performed using blast process materials containing such resin particulates in a large content. Further, a finishing can be made to the once blast processed surface.

In the blast treatment using such blast materials such as glass beads, the state of the smoothed surface can be easily controlled by, for example, a mesh size of the blast material, a blast distance (the distance between the tip of the nozzle to spray the blast material and the surface to be blast-treated), air pressure, and treatment time. Specific controlling methods are discussed below.

In addition, in the blast treatment using a metal blast material, blast processing materials such as Zn, Al, SUS, Fe, Fe cast iron can be used for blast-treatment.

At the time of blast-treatment, the roughness (concaveness and convexity) of each treated surface can be controlled to be preferably, for example, 0.05 to 1.0 μm for Ra. When Ra is too small, it is impossible to obtain a good blast-treatment effect because the mirror surface is too close. When Ra is too large, toner attachment tends to occur. This is considered to be because of super fine toner particles having a particle diameter less than 1.0 μm.

Similarly, with regard to the roughness of the blast-treated surface, when Ry is 1.0 to 5.0 μm, Rz is 1.0 to 5.0 μm, Rq is 1.0 to 5.0 μm and Ra is 1.0 to 5.0 μm, prevention effect on toner attachment is good.

The controlling methods for Ra and the others are based on blast materials, particle size, absolute specific gravity, blast spraying amount, spraying time, and underlayer processing. The most preferred conditions after spraying a blast material is that Ra is 1.0 to 5.0 μm, Ry is 0.5 to 3.0 μm, Rz is 0.5 to 3.0 μm, and Rq is 0.6 to 0.8 μm. Under these conditions, the amount of toner attachment in the classifier is significantly reduced. In addition, to efficiently achieve the surface state mentioned above, it is preferred to perform blast-treatment with metal spherical particulate blast materials having a particle diameter of from 3 to 50 μm after an underlayer treatment using a blast material formed of one of plastic particulates, glass particulates or metal particulates. However, since the blast conditions vary depending on toner materials to be pulverized and classified or the system of a device used, the blast conditions are not limited to the conditions mentioned above.

The results obtained based on the embodiment are described later with reference to Examples below.

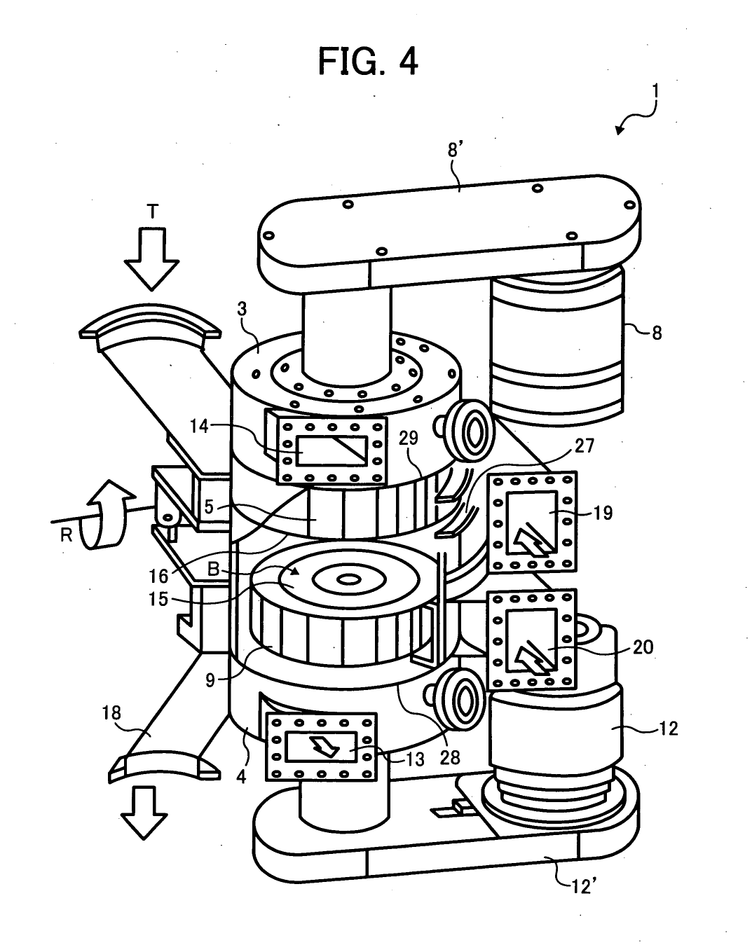

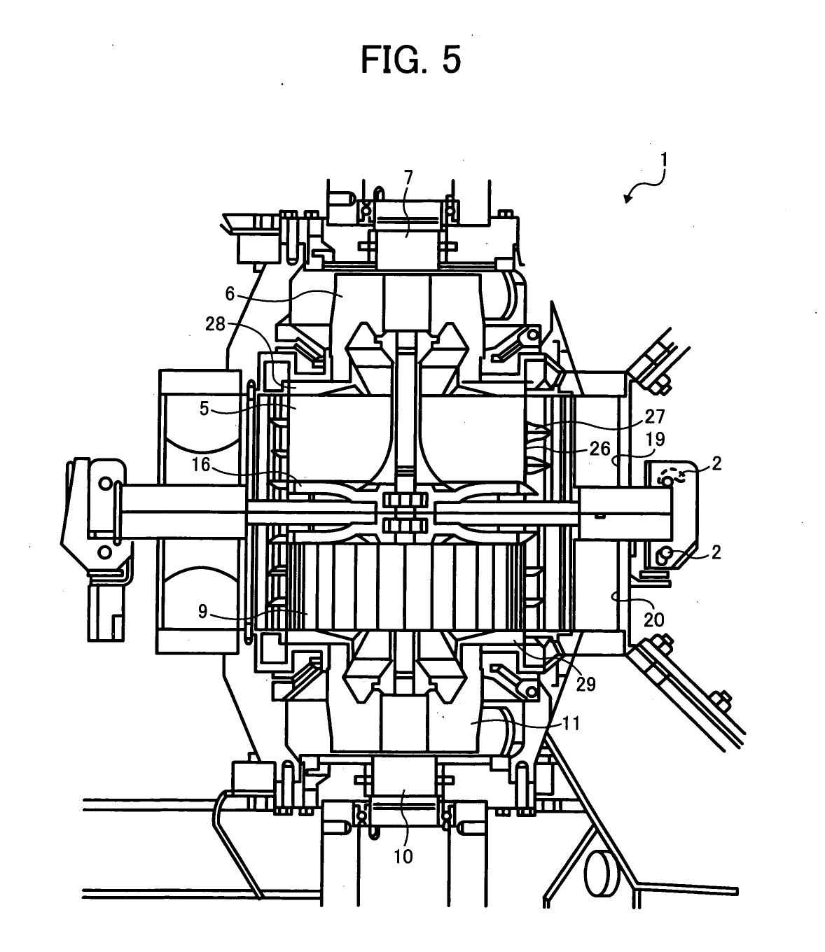

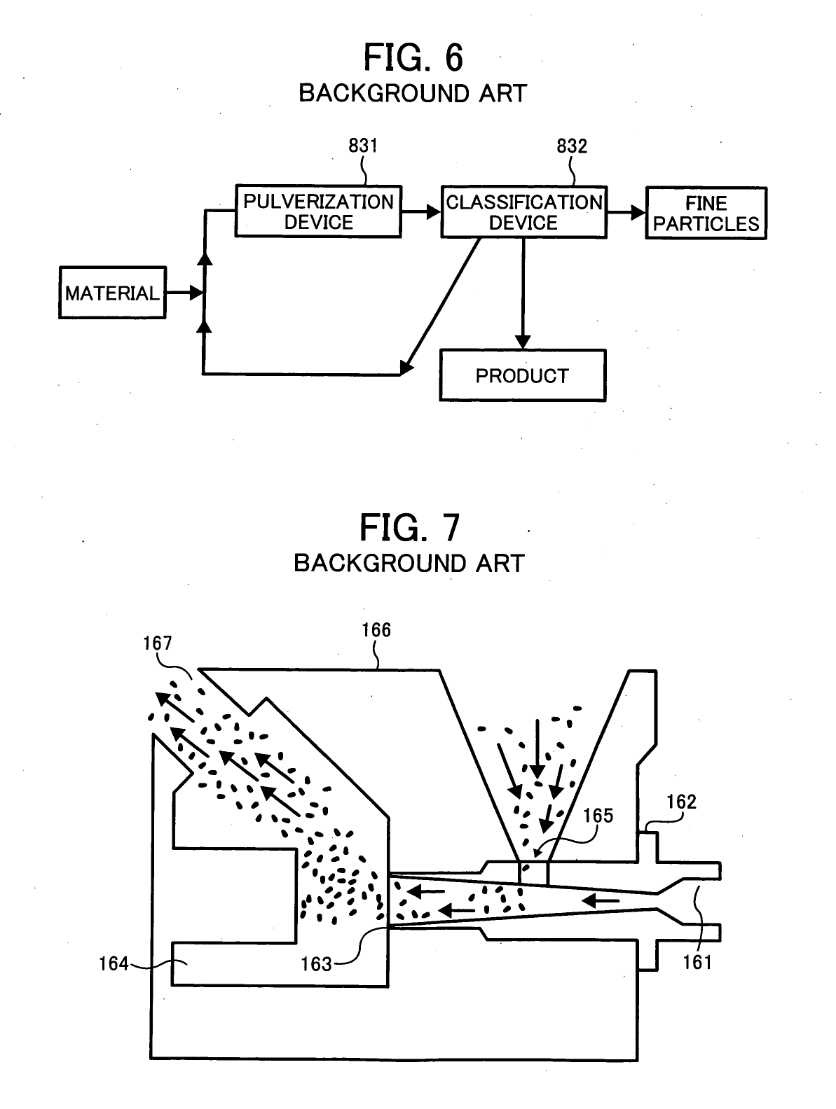

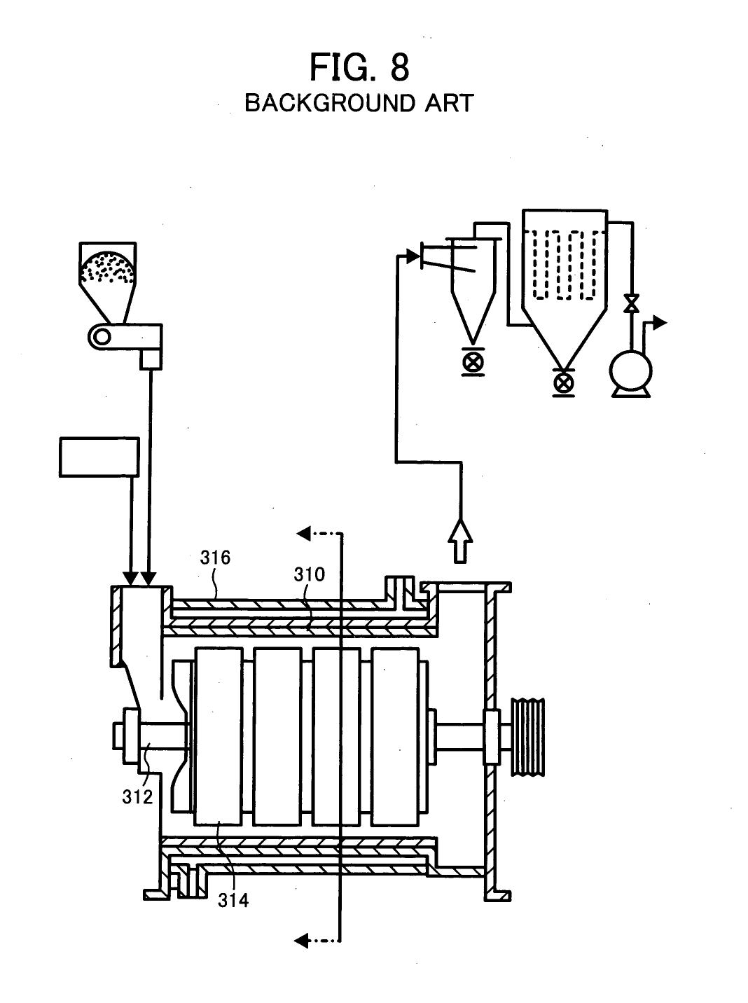

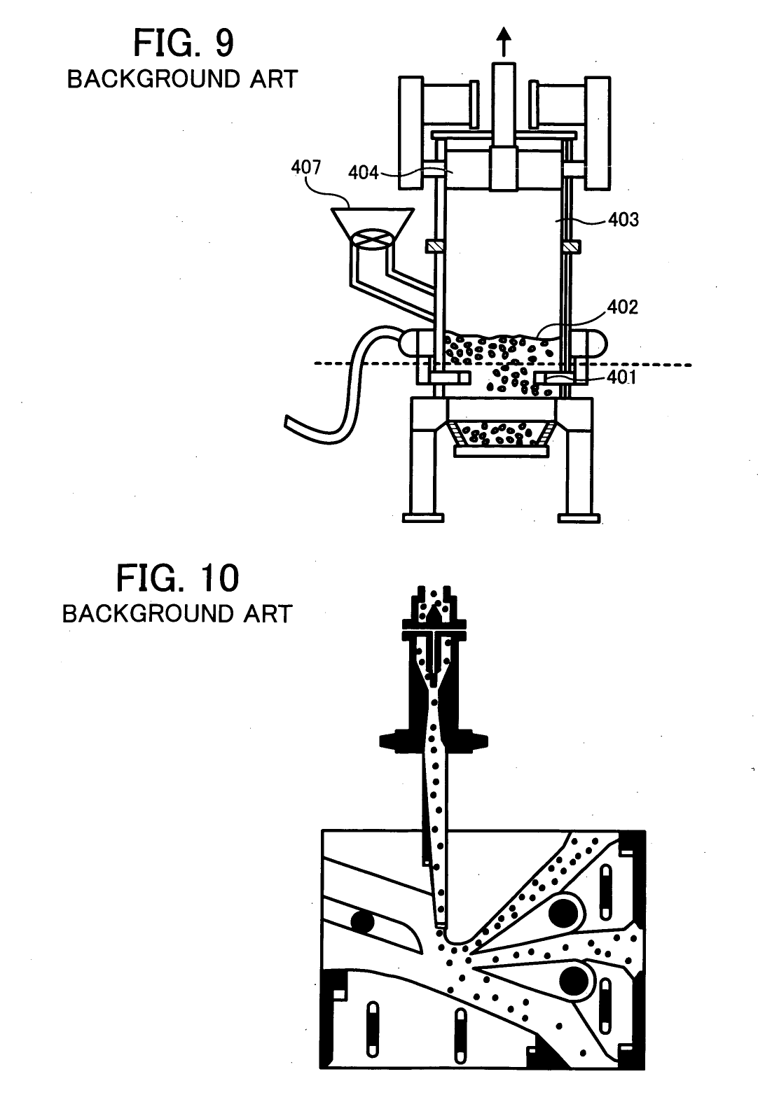

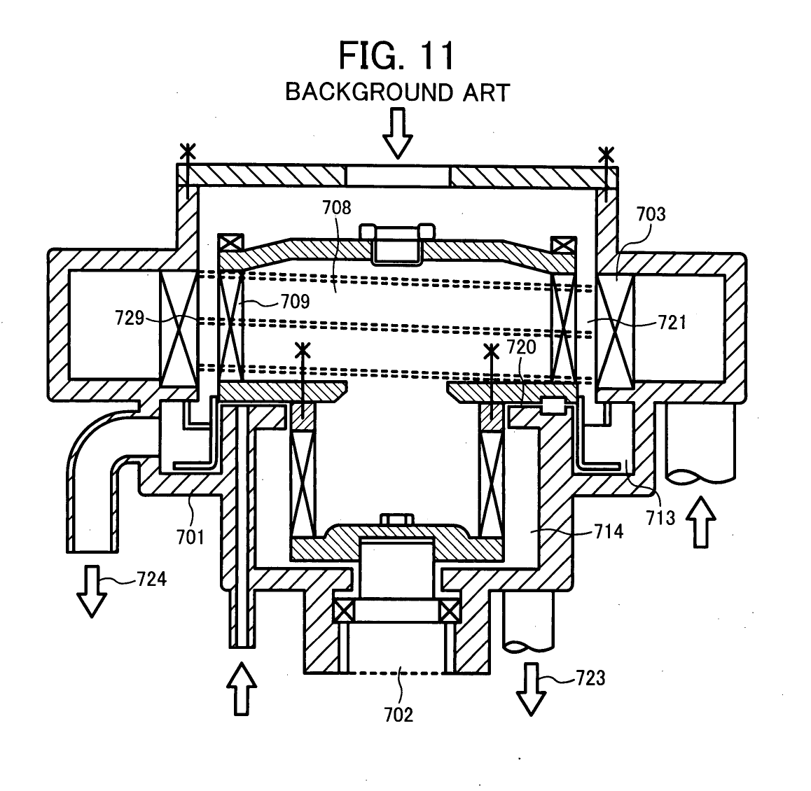

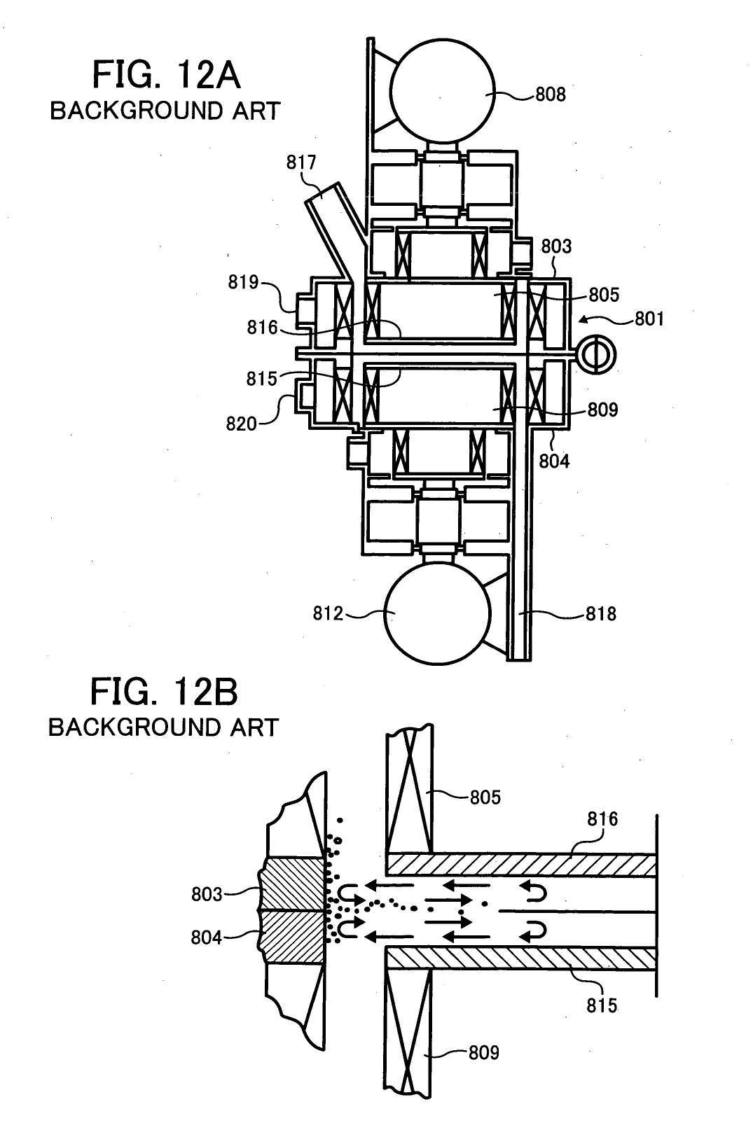

The second preferred embodiment of the present invention is now described below with reference to the drawings. FIG. 4 is a partial fractured perspective view illustrating a schematic structure of the second preferred embodiment of the classifier of the present invention. FIG. 5 is an enlarged cross section illustrating a part of the classifier of the present invention.

A classifier illustrated in FIGS. 4 and 5 has a separable casing which can open and rotate in the direction of an arrow R with a support of hinges (2). The casing includes a top half casing (3) and a bottom half casing (4). The top half and the bottom half casings (3) and (4) have classification rotors (5) and (9), respectively. In FIGS. 4 and 5, both half casings (3) and (4) are closed. In the upper half casing (3), a driving axis (7) of the classification rotor (5) is rotatably jointed in a bearing portion (6). The classification rotor (5) is driven by a driving motor (8) and this driving motor (8) is connected to the driving axis (7) and the classification rotor (5) via a transfer mechanism (8′).

Similarly, in the bottom half casing (4) symmetrically and coaxially opposing the top half casing (3), a driving axis (10) of the classification rotor (9) is rotatably jointed in a bearing portion (11). The classification rotor (9) is driven by a driving motor (12) and this driving motor (12) is connected to the driving axis (10) and the classification rotor (9) via a transfer mechanism (12′).

Each classification rotor (5) and (9) is removably supported on its half side. Each driving axis (7) and (10), each of fine particle retrieving spaces (14) and (13), and each bearing portion (6) and (11) are symmetrically and externally (top and bottom end direction) arranged in the axis direction. In addition, on each opposite side (to the central side of the axis), closed cover discs (15) and (16) are provided. To the outside based on the axis direction of the classification rotors (5) and (9), coarse particle discharging rings (centrifugal rings) (28) and (29) are provided, respectively,

To the upper side of the classification rotor (5), a short tube is arranged and particle materials (T) to be classified are input from one portion of the circumference by way of the short tube. A short tube outlet (18) for coarse particles (product) is disposed below the classification rotor (9). Reference numerals (13) and (14) represent fine particle outlets provided at the top and bottom in the axis direction. Classification air is supplied from the circumference of the classification rotors (5) and (9) via classification air supply portions (19) and (20) open to the tangent direction of each thereof.

The classification rotors (5) and (9) are symmetrically and coaxially arranged opposing each other in the classifier (1). The cover discs (16) and (15) for each rotor are separately arranged in planes parallel to each other with an interval. In this state, the classification rotors (5) and (9) rotate in the same direction. Fine particles and coarse particles can be classified by adjusting the number of rotations of the classification rotors (5) and (9) to be the same. Further, by making the number of rotation of the classification rotors (5) and (9) different, for example, fine particles can be retrieved from a fine particle retrieving space (14), middle-sized particles can be retrieved from a fine particle retrieving space (13), and coarse particles can be retrieved from the outlet short tube (18). In addition, the structure in which the classification rotors (5) and (9) rotate in the reverse direction to each other is allowed. A fkuidized space (B) is formed between the cover discs (16) and (15).

In the classification space (26) adjacent to the outer circumference of each classification rotor (5) and (9), the classifier (1) has an eddy member (27) having a spiral form on a circular member (vane ring) coaxially arranged with the classification rotors (5) and (9) to the outside of the outer circumference of the classification rotor (5) in its radius direction with an interval. There is no eddy member provided for the classification rotor (9) in FIGS. 4 and 5 but can such an eddy member can be provided thereto. The eddy member (27) is a member of controlling the floating time and agglomeration of the materials to be classified in the classification space (26), and is formed by spirally forming a material having a band form around the vane ring. The eddy member (27) is fixed to the half casings (3) and/or (4) while extending in the height direction of the classification space (26). A minute gap is formed between the inner circumference portion of the eddy member (27) and the outer circumference portion of the classification blade ring (8).

In this embodiment, among the portions classified toner particles contact among the inner side of the classifier having the structure mentioned above and the surfaces of the parts contained in the classifier (1), blast-treatment can be performed to the following portions (f) to (J), so that those portions have resulting blast-treated surface, to have a characteristic that toner attachment is efficiently prevented:
(f) for the classification rotors (5) and (9), blast-treatment is performed to their outer circumference surfaces;
(g) for the classification space (26), blast-treatment is performed to its inner circumference surface;
(h) for the coarse particle (product) discharging tube (outlet) (18), blast-treatment is performed to the inner circumference surface of the outlet;
(i) for the coarse particle discharging rings (28) and (29), blast-treatment is performed to the surfaces of the members; and
(J) for the eddy member (27), blast-treatment is performed to its surface.

The blast treatment mentioned above is limited only to effective portions in consideration of cost, but other portions could also be blast-treated. Among the parts inside the classier, the surfaces of the classification rotors (5) and (9) functioning as a rotor, and the eddy member (27) functioning as a stator are blast-treated. The blast-treatment can be the same as that of the first preferred embodiment. Therefore, a repetitive description therefor is omitted here.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the effect in each of the first and the second embodiments described above are described below with reference to Examples. First, to confirm the effect of the present invention, the method of evaluating the amount of toner attachment, and the yield of the classified product is described below. The measurement of particle size distribution is based on Coulter method. Specific examples of devices measuring particle size distribution of toner particles using the Coulter method include Coulter Counter TA-II and Coulter Multisizer II (both are manufactured by Beckman Coulter Inc.).

The measuring method is as follows:
(1) Add 0.1 to 5 ml of a surface active agent (preferably a salt of an alkyl benzene sulfide) as a dispersant to 100 to 150 ml of an electrolytic aqueous solution. The electrolytic aqueous solution is an about 1% NaCl aqueous solution prepared by using primary NaCl (e.g., ISOTON-II®, manufactured by Beckman Coulter Inc.);
(2) Add 2 to 20 mg of a measuring sample to the electrolytic aqueous solution;
(3) The electrolytic aqueous solution in which the measuring sample is suspended is subject to a dispersion treatment for 1 to 3 minutes with a supersonic disperser;
(4) Measure the volume and the number of toner particles or toner while the aperture is set to 100 μm for the measuring device mentioned above to calculate the weight distribution and number distribution of the toner; and
(5) Based on the distributions obtained as mentioned above, the weight average particle diameter (D4) and the number average particle diameter (D1) of the toner are obtained.

The whole range of target particles is particles having a particle diameter of from 2.00 to not greater than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

Example of Toner Manufacturing

Pulverized material to be tested was obtained as follows:
(1) fusion-knead the following mixture with a two-axis kneading device;
(2) subsequent to cooling down and solidification of the resultant, pulverize the resultant to obtain toner material; and
(3) pulverize 500 kg of the toner material with a jet mill to obtain the pulverized material to be tested having a weight average particle diameter not greater than 5.08 μm with particles having not greater than 4 μm in an amount of 58.3% by number.

The ratio (D4/D1) of the weight average particle diameter (D4) to the number average particle diameter (D1) was 1.32.

The surface roughness was measured by a surface tester type 500, manufactured by Mitutoyo Corporation.

(TSP)

The initial condition was set for the pulverized material to be tested obtained as mentioned above such that the ratio (D4/D1) of the classified product was 1.20. In Example 1 and Comparative Example 1, 200 kg of the pulverized material was continuously processed with a TSP having a rotor diameter of 200 mm under the condition that the number of rotations was 5,700 rpm and the material supplying rate was 60 kg/hour. In Example 1, the TSP used was blast-treated and in Comparative Example 1, the TSP used was not blast-treated. The evaluation was made on toner attachment for the following:
(1) whether toner fixation occurred on the outer circumference surface of the classification rotor;
(2) amount and state of the toner attachment at the outlet for coarse particles (product);
(3) amount and state of the toner attachment at the coarse particle discharging ring;
(4) amount and state of the toner attachment at the eddy member;
(5) yield of the classified product;
(6) the ratio (D4/D1) of the classified product obtained at the time of processing the last 10 kg of the 200 kg continuous treatment; and
(7) the content ratio of the classified product having a particle diameter not greater than 4 μm in the classified product at the time of processing the last 10 kg of the 200 kg continuous treatment.

The surface roughness in the case of the blast treatment of the present invention (i.e., Example 1) is: the average of Ra: 0.40 μm; the average of Ry: 2.16 μm; the average of Rz: 2.33 μm; and the average of Rq: 0.55 μm.

Characters Ra, Ry, Rz, and Rq represent the degree of roughness of a surface as follows:
Ra represents the average of the aggregated absolute values for portions extruding to the convex side based on the average line;
Ry represents the sum of the height of the most extruding portion based on the average line and the depth of the most dented portion based thereon;
Rz represents the sum of the average of the first to fifth most extruding portion based on the average line and the average of the first to fifth most dented portion based on the average line; and
Rq represents the square root of the average of the sum of the square of the deviation between the average line and a measured line.

The surface roughness in the case of the non-blast treatment (i.e., Comparative Example 1) is: the average of Ra: 1.6 μm; the average of Ry: 6.3 μm; and the average of Rz: 6.3 μm.

(TTSP)

Similarly, the initial condition was set for the pulverized material to be tested obtained as mentioned above such that the ratio (D4/D1) of the classified product was 1.20. In Example 2 and Comparative Example 2, 200 kg of the pulverized material was continuously processed with a TTSP having a rotor diameter of 200 mm under the condition that the number of rotations was 5,700 rpm and the material supplying rate was 60 kg/hour. In Example 2, the TTSP used was blast-treated and in Comparative Example 2, the TTSP used was not blast-treated. The evaluation was made on toner attachment for the (1) to (7) mentioned above:

The surface roughness in the case of the blast treatment of the present invention (i.e., Example 2) is: the average of Ra: 0.40 μm; the average of Ry: 2.16 μm; the average of Rz: 2.33 μm; and the average of Rq: 0.55 μm.

The surface roughness in the case of the non-blast treatment (i.e., Comparative Example 1) is: the average of Ra: 1.6 μm; the average of Ry: 6.3 μm; and the average of Rz: 6.3 μm.

The evaluation results of Examples 1 and 2, and Comparative Examples 1 and 2 are shown in Table 1.

TABLE 1

| | | | | | | | | 7. Content |
|---|---|---|---|---|---|---|---|---|
| | | | | | | | | ratio of the |
| | | | | | | | | classified |
| | | | | | | | | product |
| | | | | | | | 6. Ratio | having a |
| | | | | | | | (D4/D1) of | particle |
| | | | | | | | the | diameter |
| | | | | | | | classified | not greater |
| | | | 2. Amount | | | | product | than 4 μm in |
| | | | and state | 3. Amount | | | obtained | the |
| | | 1. Whether | of the | and state of | | | at the time | classified |
| | | toner fixation | toner | the toner | | | of | product at |
| | | occurred on the | attachment | attachment | 4. Amount and | | processing | the time of |
| | | outer | at the | at the | state of the | | the last 10 kg | processing |
| | | circumference | outlet for | coarse | toner | 5. Yield of | of the | the last 10 kg |
| | | surface of the | coarse | particle | attachment | the | 200 kg | of the 200 kg |
| | | classification | particles | discharging | at the eddy | classified | continuous | continuous |
| | | rotor | (product) | ring | member | product | treatment | treatment |
| Example 1 | TSP | Extremely | Attachment | Attachment | Attachment | 86% | 1.19 | 43.1 |
| | (Blast | limited amount | in a small | in a small | in a small | | | |
| | treated: | | amount | amount | amount | | | |
| | ((a) | | | | | | | |
| | to(e)) | | | | | | | |
| | (FIG. 2) | | | | | | | |
| Comparative | TSP | Fixation | Attachment | Attachment | Attachment | 75% | 1.26 | 52.5 |
| Example 1 | | occurred on the | progresses | occurred | occurred and | | | |
| | | outer | and part of | and part of | attached | | | |
| | | circumference. | the outlet | attached | particles | | | |
| | | The fixated | was | particles | were | | | |
| | | material was | clogged. | was | accumulated | | | |
| | | detached and | | fixated. | on the eddy | | | |
| | | interfused in | | | member. | | | |
| | | the coarse | | | | | | |
| | | particles | | | | | | |
| | | (product). | | | | | | |
| Example 2 | TTSP | Extremely | Attachment | Attachment | Attachment | 88% | 1.17 | 39.4 |
| | (Blast | limited amount | in a small | in a small | in a small | | | |
| | treated | | amount | amount | amount | | | |
| | ((f) to | | | | | | | |
| | (j)) | | | | | | | |
| | (FIG. 4) | | | | | | | |
| Comparative | TTSP | Fixation | Attachment | Attachment | Attachment | 78% | 1.25 | 51.2 |
| Example 2 | (Non- | occurred on the | progresses | occurred | occurred and | | | |
| | blast | outer | and part of | and part of | attached | | | |
| | treated) | circumference. | the outlet | attached | particles | | | |
| | | The fixated | was | particles | were | | | |
| | | material was | clogged. | was fixated | accumulated | | | |
| | | detached and | | | on the eddy | | | |
| | | interfused in | | | member. | | | |
| | | the coarse | | | | | | |
| | | particles | | | | | | |
| | | (product). | | | | | | |

(Image Output Example 1)

In addition, Toner A was prepared in the following manner:
(1) add 0.2 parts by weight of silica particulate and 0.2 parts of titanium oxide to 100 parts of the classified product obtained in Example 2;
(2) mix these with a HENSCHEL mixer; and
(3) sieve the mixture.

Thereafter, Two component developer A was obtained by mixing 5 parts by weight of Toner A with 95 parts by weight of silicon coated carrier having a weight average particle diameter of 60 μm with a turbula mixer.

This two-component developer A was set in IPSIO COLOR 8150 (manufactured by Rico, Co) to output images. The images obtained were extremely vivid and clear with smooth gradation.

(Image Output Example 2)

Next, Toner B was prepared from the classified product obtained in Comparative Example. 2 in the same manner as mentioned in Image output example 1 by mixing silica and titanium oxide.

A two component developer B was prepared in the same manner as mentioned in Image output example 1.

Images were output in the same manner as mentioned in Image output example 1. The images obtained were relatively less vivid, clear and rugged in comparison with those of Image output example 1.

As detailed above, it is found that, when the classifier of the present invention is used, toner attachment rarely occurs and classification of toner particles is stably secured. The same technology can be applied to other toner manufacturing devices such as a pulverizer and a mixing device to prevent toner attachment to the inner side thereof for an extended period of time and thereby, desired processing can be stably performed for a long period of time, resulting in production of toner in a great amount with a high yield.

The present invention can be applied not only to the classifiers detailed in the embodiments but also to typical toner manufacturing devices. For example, the present invention can be applied to the various kinds of pulverizers described as the background art to prevent toner attachment. Naturally, the present invention can be applied to a toner mixing device and considerably exercises a toner attachment prevent effect therefor.

In addition, to manufacture a toner by the toner manufacturing method of the present invention, at least one of the manufacturing devices described in the present invention is used to structure a manufacturing system. As a result of the high grade treatment in the manufacturing devices according to the present invention, toners capable of exercising a high performance can be stable manufactured. Further, efforts and energy on maintenance at the manufacturing devices can be saved, which leads to cost reduction.

This document claims priority and contains subject matter related to Japanese Patent Applications Nos. 2004-272436, 2005-075244, and 2005-216675, filed on Sep. 17, 2004, Mar. 16, 2005, and Jul. 27, 2005, respectively, the entire contents of each of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner classification device, comprising:
a casing, comprising;
at least one classification space, comprising:
a classification rotor; and
a toner discharging outlet,
wherein at least a portion of a surface of part of an inner surface of the toner classification device which toner particles contact includes a blast-treated surface.

2. The toner classification device according to claim 1, wherein the casing comprises at least two classification spaces, the at least two classification spaces being coaxially arranged to perform classification at least twice.

3. The toner classification device according to claim 1, wherein the blast treated surface has Ra of 0.05 to 1.0 μm.

4. The toner classification device according to claim 1, wherein the blast treated surface has Ry of 1.0 to 5.0 μm.

5. The toner classification device according to claim 1, wherein the blast treated surface has Rz of 1.0 to 5.0 μm.

6. The toner classification device according to claim 1, wherein the blast treated surface has Rq of 1.0 to 5.0 μm.

7. The toner classification device according to claim 1, wherein the blast-treated surfaces are made by a blast treatment performed using one of plastic fine particles, glass fine particles, metal fine particles, and metal spherical fine particles.

8. The toner classification device according to claim 1, wherein at least part of a surface of the classification rotor is a blast-treated surface.

9. The toner classification device according to claim 1, wherein at least part of a surface of the classification space is a blast-treated surface.

10. The toner classification device according to claim 1, wherein at least part of an inner wall of the toner discharging outlet is a blast-treated surface.

11. The toner classification device according to claim 1, further comprising:
a toner discharging ring located at an end in an axial direction of the casing,
wherein the toner discharging ring includes a blast treated surface.

12. The toner classification device according to claim 1, further comprising:
an eddy member located at a lateral face of the casing,
wherein the eddy member includes a blast-treated surface.

13. A method of manufacturing a toner, comprising:
pulverizing a material comprising a binder resin with a pulverizing device;
classifying the pulverized material with a classification device comprising a casing comprising at least one classification space comprising a classification rotor and a toner discharging outlet,
wherein at least a portion of an inner surface of the toner classification device which toner particles contact includes a blast-treated surface.

14. A blast treatment method, comprising:
blast treating at least part of at least one of inner surface of a classification device and a surface of parts thereof which toner particles contact with fine particles having a hardness of from 3 to 8 on Mohs hardness.

15. Toner made by a method, comprising:
pulverizing a material comprising a binder resin with a pulverization device;
classifying the pulverized material with a classification device comprising a casing comprising at least one classification space comprising a classification rotor and a toner discharging outlet,
wherein at least a portion of an inner surface of the toner classification device which toner particles contact includes a blast-treated surface.

16. The toner according to claim 15, wherein the blast-treated surface has Ra of 0.05 to 1.0 μm.

17. The toner according to claim 15, wherein the blast-treated surface has Ry of 1.0 to 5.0 μm.

18. The toner according to claim 15, wherein the blast-treated surface has Rz of 1.0 to 5.0 μm.

19. The toner according to claim 15, wherein the blast-treated surface has Rq of 1.0 to 5.0 μm.
